(19) United States
(12) Patent Application Publication
(10) Pub. No.: US 2014/0229884 A1
(43) Pub. Date: Aug. 14, 2014

(54) TERMINAL DEVICE, INFORMATION INPUT METHOD, AND PROGRAM

(71) Applicant: Mamoru Shimazaki, Kanagawa (JP)

(72) Inventor: Mamoru Shimazaki, Kanagawa (JP)

(73) Assignee: NEC CASIO MOBILE COMMUNICATIONS, LTD., Kawasaki-shi, Kanagawa (JP)

(21) Appl. No.: 14/342,882

(22) PCT Filed: Sep. 5, 2012
(86) PCT No.: PCT/JP2012/072626

§ 371 Date: Mar. 5, 2014

(30) Foreign Application Priority Data
Sep. 7, 2011 (JP) 2011-195221

(51) Int. Cl. G06F 3/0484; G06F 3/0488

(52) U.S. Cl. CPC G06F 3/0484; G06F 3/04886
USPC 715/773

(57) ABSTRACT

To provide a terminal device, an information input method, and a program, capable of facilitating input of information of two or more digits or two or more characters. The terminal device comprises an operation unit configured to receive an operation from a user, a display unit configured to display an operation object capable of being operated by the user, an operation recognition unit configured to change input information having a length of two or more digits or two or more characters according to an amount of operation on the operation object and based on a predetermined rule, and a control unit configured to perform a predetermined process using input information selected by the operation on the operation object.

### CROSS-REFERENCE TO RELATED APPLICATIONS

The present invention is based upon and claims the benefit of the priority of Japanese Patent Application No. 2011-195221 (filed on Sep. 7, 2011), the disclosure of which is incorporated herein in its entirety by reference.

### TECHNICAL FIELD

The present invention relates to a terminal device, an information input method, and a program. More specifically, the invention relates to a terminal device, an information input method, and a program, configured to receive input of information using a graphical user interface (GUI).

### BACKGROUND

Among cellular phone terminals, a terminal into which character input referred to as flick input can be performed is becoming widespread. The flick input is performed instead of use of an input interface for a conventional toggle input method. In the toggle input method, one or a plurality of times of button operations are needed for input of one character. In a common personal computer or the like as well, one or more key depressions are necessary for input of one character in both of methods of input of Roman characters and hiragana characters.

Patent Literature 1 discloses an input method of a password. In this method, a figure having a matrix shape is displayed. In this figure, numerical key (termed as “ten-key”) numbers are replaced with nodes (input points). When the password is input, a line connecting the nodes (input points) is displayed on the figure having the matrix shape.

Patent Literature 2 discloses an authentication device configured to perform user authentication according to whether the shape of a line that has been hand-written with a single stroke line (stroke) and input matches a template input in advance.

### CITATION LIST

### Patent Literature

[Patent Literature 1]
JP Patent Kokai Publication No. JP2006-107411A
[Patent Literature 2]
JP Patent Kokai Publication No. JP2009-163482A

### SUMMARY

### Technical Problem

The following analysis has been given by the present invention. As described above, in the toggle input method, one or a plurality of times of button operations are needed for input of one character. Even in the flick input, one time of operation of sliding a target button on a touch panel in the direction of a target character with a finger is needed. Further, also in a personal computer or a portable terminal including a keyboard, one or a plurality of times of button operations are needed for input of one character, unless a special key assignment is employed.

Patent Literature 1 describes as if a plurality of numbers can be input just by drawing a figure. However, the figure is presented merely to facilitate memorization of the password. The method disclosed in Patent Literature 1 remains unchanged from an operation using existent-ten keys in that one time of operation is needed for input of one character.

Patent Document 2 discloses authentication using a hand-written signature (signature), and any particular proposal is not made for efficiently performing input of information.

It is an object of the present invention to provide a terminal device, an information input method, and a program, capable of contributing to facilitating input of information with a length of two or more digits or two or more characters (or letters, generally represented by “character(s)” herein).

### Solution to Problem

According to a first aspect, there is provided a terminal device comprising:
an operation unit configured to receive an operation from a user;
a display unit configured to display an operation object (an object which is displayed on a screen and on which a user can perform a certain operation being hereinafter referred to as the “operation object”) capable of being operated by the user;
an operation recognition unit configured to change input information having a length of two or more digits or two or more characters according to an amount of operation on the operation object and based on a predetermined rule; and
a control unit configured to perform a predetermined process using input information selected by an operation on the operation object.

According to the terminal device as mentioned above, by operating the operation object such that each digit or each character of the input information assumes a desired value, the respective two or more digits or the respective two or more characters of the information can be simultaneously input.

According to a second aspect, there is provided an information input method comprising the steps of:
displaying on a display device an operation object capable of being operated by a user;
changing input information having a length of two or more digits or two or more characters according to an amount of operation on the operation object and based on a predetermined rule; and
receiving selection of input information by a predetermined operation. This method is tied to a specific machine, which is a computer configured to receive input of the information from the user.

According to a third aspect, there is provided a program for causing a computer including an operation unit configured to receive an operation from a user and a display unit, the program causing the computer to execute the processes of:
displaying an operation object capable of being operated by the user;
changing input information having a length of two or more digits or two or more characters according to an amount of operation on the operation object and based on a predetermined rule; and
receiving selection of input information by a predetermined operation. This program can be recorded in a storage medium capable of being read by the computer. That is, the present invention can also be embodied as a computer product.

### Advantageous Effects of Invention

The present invention can contribute to readily inputting of input information of two or more digits or two or more characters (or letters).

### BRIEF DESCRIPTION OF THE DRAWINGS

FIG. 1 is a diagram for explaining an overview of the present invention.

FIG. 2 is another diagram for explaining the overview of the present invention.

FIG. 3 is another diagram for explaining the overview of the present invention.

FIG. 4 is a block diagram showing a configuration of a cellular phone terminal according to a first exemplary embodiment of the present invention.

FIG. 5 shows an example of a password stored in a password storage unit in FIG. 4.

FIG. 6 is a flow diagram showing operations of the cellular phone terminal according to the first exemplary embodiment of the present invention.

FIG. 7 shows an example of a password input screen of the cellular phone terminal according to the first exemplary embodiment of the present invention.

FIG. 8 is a diagram following FIG. 7.

FIG. 9 shows an example of a password input screen of a cellular phone terminal according to a second exemplary embodiment of the present invention.

FIG. 10 shows an example of a password stored in a password storage unit for the cellular phone terminal in the second exemplary embodiment of the present invention.

FIG. 11 is a diagram following FIG. 9.

FIG. 12 shows an example of a password input screen of a cellular phone terminal according to a third exemplary embodiment of the present invention.

FIG. 13 is a diagram following FIG. 12.

FIG. 14 is a diagram following FIG. 13.

FIG. 15 is a diagram following FIG. 14.

FIG. 16 is a diagram following FIG. 15.

FIG. 17 shows an example of a password input screen of a cellular phone terminal according to a fourth exemplary embodiment of the present invention.

FIG. 18 is a diagram following FIG. 17.

FIG. 19 shows an example of a screen for input of a calling telephone number in a cellular phone terminal according to a fifth exemplary embodiment of the present invention.

FIG. 20 is a diagram following FIG. 19.

FIG. 21 shows an example of a screen for calling up telephone directory data in a cellular phone terminal according to a sixth exemplary embodiment of the present invention.

FIG. 22 is a diagram following FIG. 21.

FIG. 23 shows an example of a screen of a schedule book in a cellular phone terminal according to a seventh exemplary embodiment of the present invention.

FIG. 24 shows an example of a screen for selection of an input method in a cellular phone terminal according to an eighth exemplary embodiment of the present invention.

### MODES FOR CARRYING OUT THE INVENTION

First, an overview of the present invention will be described with reference to drawings. In the following description, a reference symbol referring to drawings appended to this overview is added to each component for convenience, as an example for helping understanding, and is not intend to limit the present invention to the modes illustrated in the drawings.

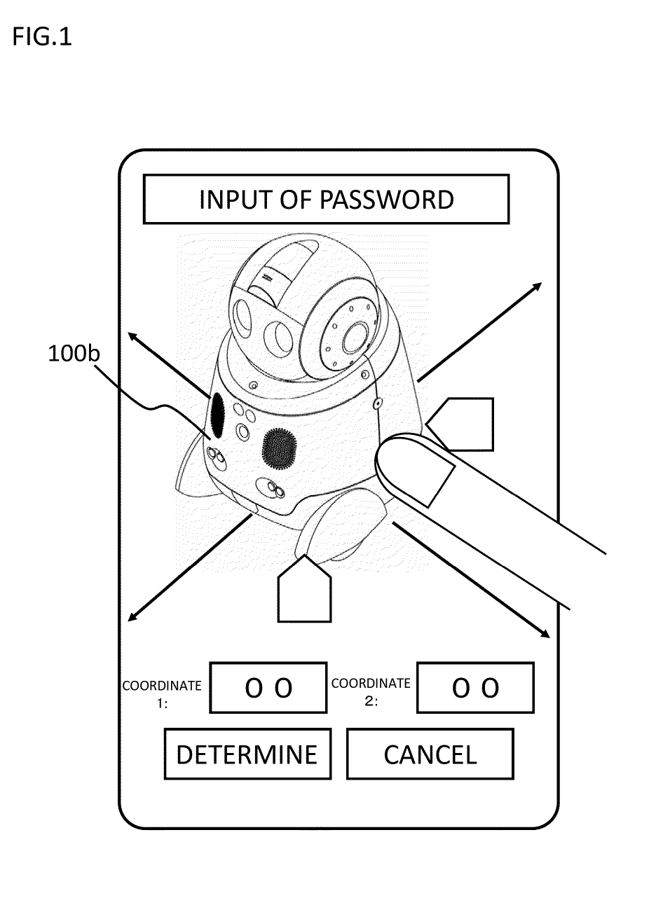

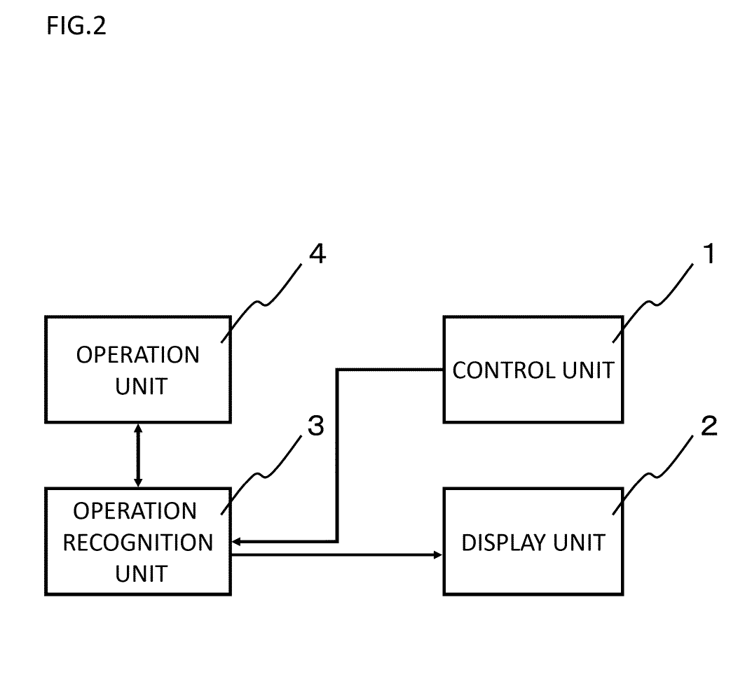

A terminal device according to an exemplary embodiment of the present invention includes an operation unit (1 in FIG. 2) configured to receive an operation from a user, a display unit (2 in FIG. 2) configured to display an operation object (100b in FIG. 1) that can be operated by the user, an operation recognition unit (3 in FIG. 2) configured to change input information having a length of two or more digits or two or more characters according to an amount of operation on the operation object (100b in FIG. 1) and based on a predetermined rule, and a control unit (4 in FIG. 2) configured to perform a predetermined process using information selected by an operation on the operation object (100b in FIG. 1). As the operation unit, a so-called pointing device such as a mouse, a touch panel, a joystick, a trackball, a pen tablet, or a write pen can be preferably employed in order to instruct and input movement, rotation, or the like of the operation object.

When the user moves the operation object 100b in FIG. 1 having a shape of a robot, the operation recognition unit (3 in FIG. 2) changes values of a coordinate 1 and a coordinate 2 shown in a lower position of FIG. 1, according to an amount and a direction of an operation by the user. When the user operates the operation object so that values of the respective coordinates constitute a password set in advance and then clicks a “determine” button, the control unit (4 in FIG. 2) receives from the operation recognition unit (3 in FIG. 2) the values of the coordinate 1 and the coordinate 2 at that point, and executes a user authentication process using the password. As described above, according to the present invention, respective information items of two or more digits, or two or more characters can be simultaneously input by a simple operation.

In the example in FIG. 1, the description was given, assuming that the values of the coordinate 1 and the coordinate 2 shown in the lower position of FIG. 1 are to be changed according to the amount and the direction of the operation by the user. However, display of the coordinates 1 and 2 can also be omitted by displaying a scale(s), an auxiliary line(s), or a grid(s) in a movable range of the operation object 100b, for example.

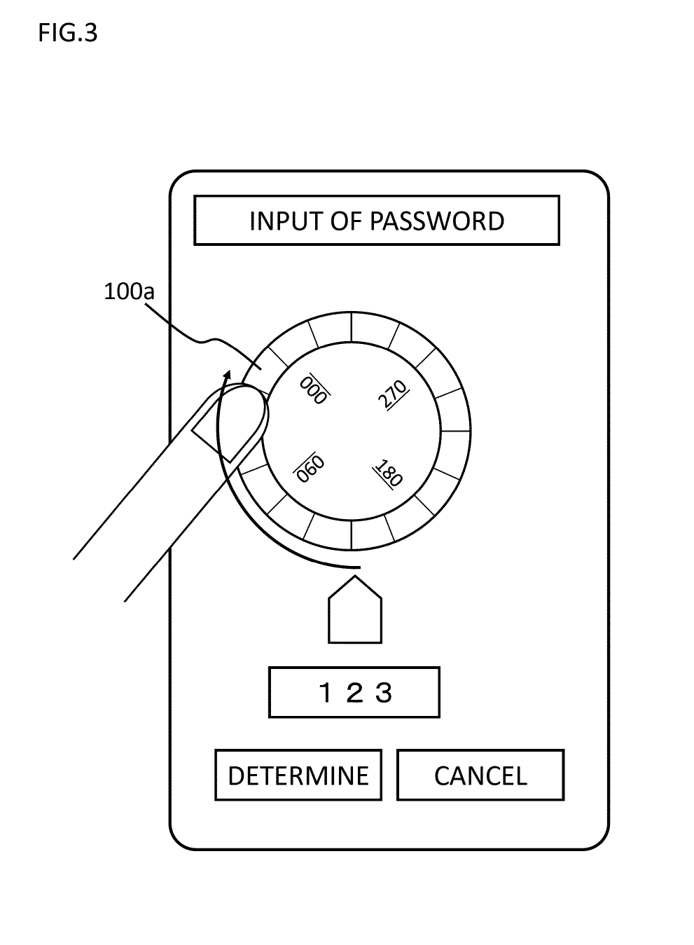

In the example in FIG. 1, the operation object 100b in the shape of the robot capable of being freely moved in front and back directions, right and left directions, and an oblique direction is employed. The shape and the movement of the operation object are not limited to these. To take an example, as shown in FIG. 3, an operation object 100a in the shape of a dial capable of being rotated clockwise and anticlockwise may be employed, thereby allowing selection of input information (“123” in the example in FIG. 3) according to an amount (angle in the example in FIG. 3) of operation on the operation object 100a. Further, it may be so arranged that an operation in a depth direction of the screen is made possible by a specific operation, and an amount of operation is used as input information.

In the examples in FIGS. 1 and 3, the value selected using each of the operation objects 100a and 100b is employed as a password for the user authentication process. The value selected by using each of the operation objects 100a and 100b can be used as input information for various processes. To take an example, a user ID, a PIN (Personal Identification Number) code, a calling telephone number, or a number for telephone directory data may be pointed out as the input information.

The value selected using each of the operation objects 100a and 100b does not need to be a number. Assume, for example, that it is so arranged that the value of the coordinate 1 changes like “AA, AB, AC, . . . , AZ, BA, BB, . . . ” [alphabet letter sets] or “aa, ai, au, . . . awo, ia, ii, . . . ” [Japanese syllable letter sets] when the operation object 100b in the shape of the robot in FIG. 1 is moved back and forth. Then, the operation object can also be used for input of two or more characters. It may also be so arranged that in place of these characters, a figure, a pictograph, a face mark, or the like is changed based on the predetermined rule. Accordingly, the present invention can be suitably used also when input of a password using alphabets, “kana” characters [Japanese syllable characters], or the like, input of a code including an alphabet(s) and a number(s) such as a product number, or input of a short phrase is requested.

### First Exemplary Embodiment

Next, with reference to drawings, a description will be given in detail about a first exemplary embodiment where the present invention is applied to an input interface of a cellular phone terminal of touch panel type.

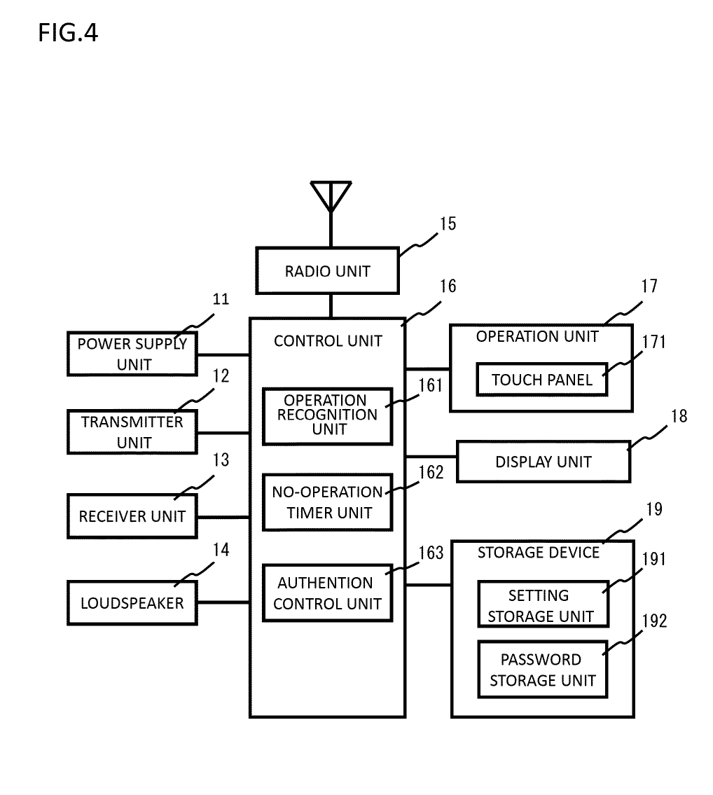

FIG. 4 is a block diagram showing a configuration of a cellular phone terminal according to the first exemplary embodiment of the present invention. Referring to FIG. 4, the configuration including a power supply unit 11, a transmitter unit 12, a receiver unit 13, a loudspeaker 14, a radio unit 15, a control unit 16, an operation unit 17, a display unit 18, and a storage device 19 is shown. The power supply unit 11 provides electric power to an entirety of the cellular phone terminal. The transmitter unit 12 transmits a voice signal of a user to the other party. The receiver unit 13 transmits a voice signal of the other party to the user. The loudspeaker 14 gives out music, voice, and notification sound to the user. The radio unit 15 is connected to a radio communication network through an antenna. The operation unit 17 receives an operation for an outgoing call, an incoming call, or each of various functions of the cellular phone terminal. The display unit 18 displays various information (items). The storage device 19 stores a state of the cellular phone terminal, data, and the like.

The operation unit 17 includes a touch panel 171 installed on the surface of the display unit 18. In the following description, it is assumed that a user performs an operation through this touch panel 171.

The control unit 16 includes an operation recognition unit 161 configured to control a combination of the display unit 18 and the touch panel 171, a no-operation timer unit 162 configured to detect presence or absence of a signal from the operation unit 17 or the like and to reduce brightness of a backlight or turns off the backlight when there is no operation from the user within a preset period of time, and an authentication control unit 163 configured to compare a password registered in advance and an input password, for determination, or the like.

The storage device 19 includes a setting storage unit 191 configured to store and memorize various setting information of the phone and a password storage unit 192 configured to store the password registered in advance.

In the setting storage unit 191, in addition to the various setting information, a flag indicating whether or not to perform an operation lock that will be described later, a requirement for requesting input of a password and starting a user authentication process, such as a touch panel operation, opening or closing of a housing, a slide operation, key depression, or operation detection by an acceleration sensor, and the like are stored,.

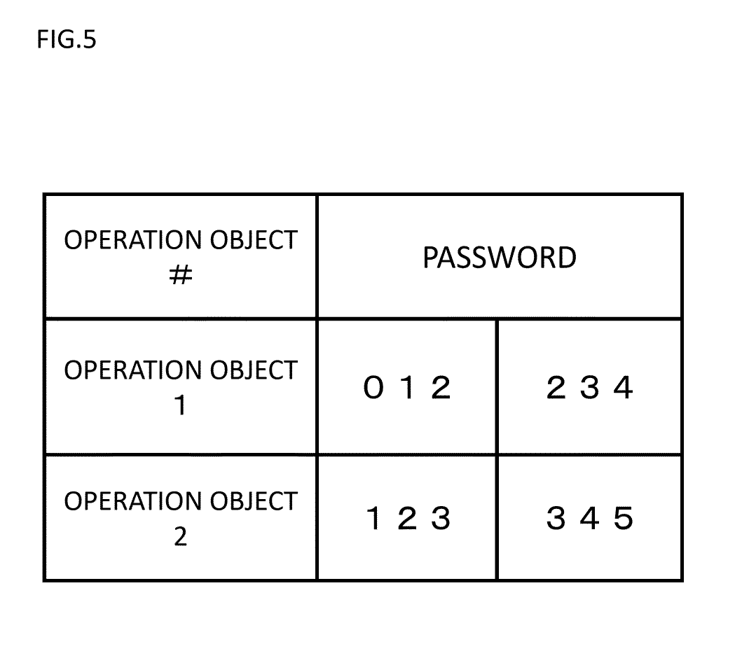

FIG. 5 shows an example of a registered password stored in the password storage unit 192. Hereinafter, it is assumed in this exemplary embodiment that a 12-digit password of “012234123345” is set. Respective three-digit numbers of the 12-digit password are associated with respective operation object #1 and operation object #2. In the example in FIG. 5, by performing an operation such that first input information (item) and second input information (item) which change by operating the operation object #1, respectively become “012” and “234”, and then by performing an operation such that first input information and second input information which change by operating the operation object #2, respectively become “123” and “345”, input of a password identical to the registered password is completed.

Each unit (processing means) within the control unit 16 of the cellular phone terminal shown in FIG. 4 can also be implemented by a computer program. The computer program is configured to cause a computer constituting the control unit of the cellular phone terminal to execute each process that will be described later, using hardware of the computer.

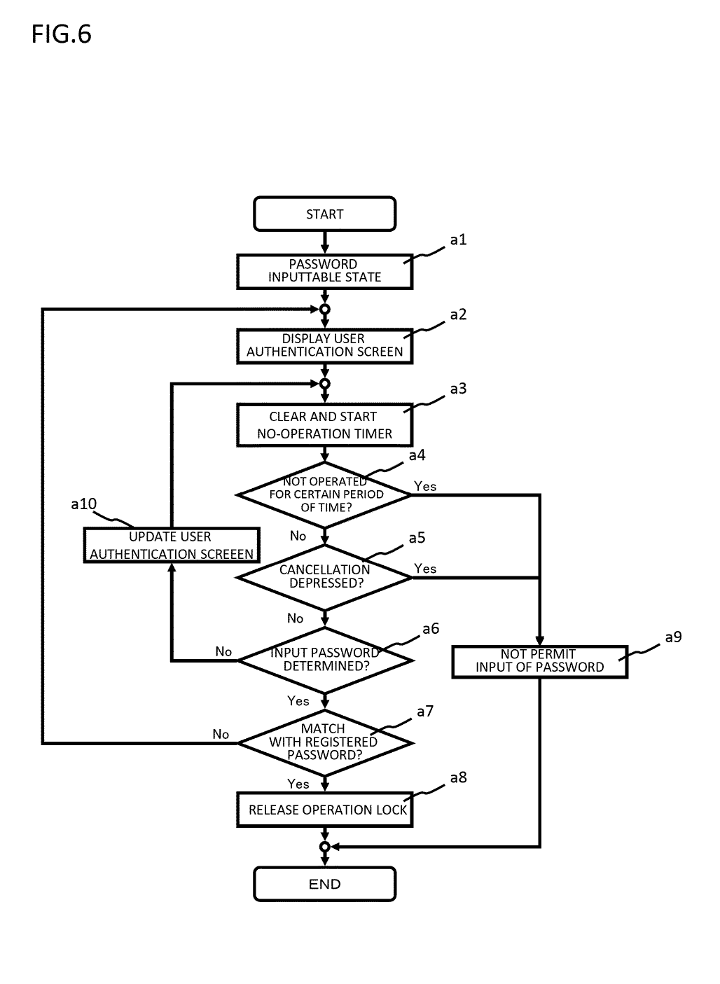

Next, operations of the cellular phone terminal described above will be described in detail with reference to drawings. FIG. 6 is a flow diagram showing the operations of the cellular phone terminal according to the first exemplary embodiment of the present invention. In the following description, the description will be given, assuming that the cellular phone terminal is in an operation locked state in which use of a telephone-call sending and receiving function and a mail function is limited.

When the requirement for starting the user authentication process stored in the setting storage unit 191 is established, the cellular phone terminal transitions to a state in which the password can be input (in step a1).

Next, the cellular phone terminal displays on the display unit 18 a user authentication screen where operation objects and display fields of input information are disposed (in step a2).

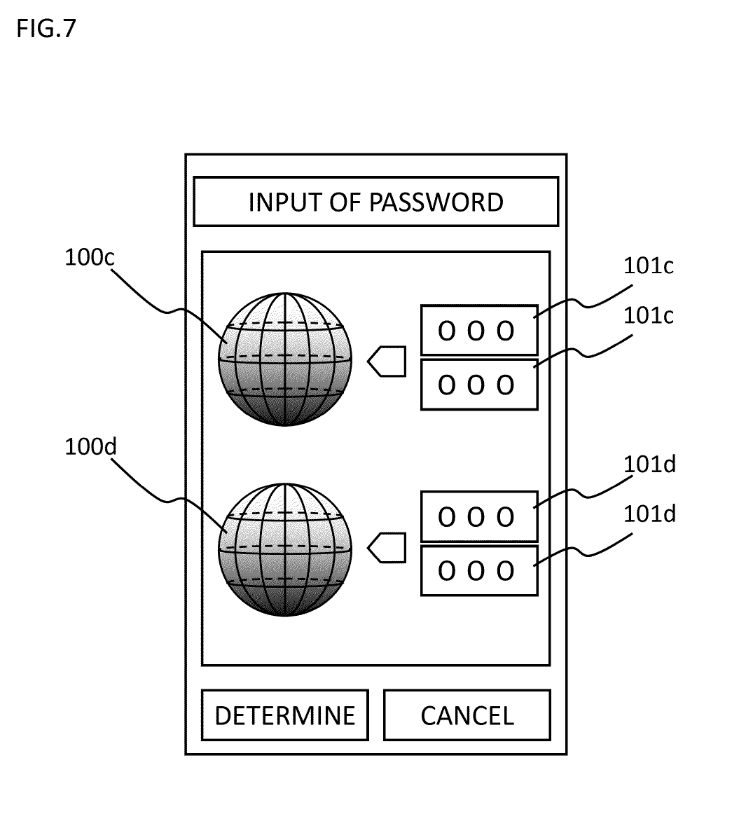

FIG. 7 shows an example of a password input screen displayed on the display unit 18. In the example in FIG. 7, two operation objects of an operation object 100c (corresponding to the operation object #1) and an operation object 100d (corresponding to the operation object #2) in the shapes of spherical bodies and four input information display fields 101c and 101d whose values change according to movements of these operation objects 100c and 100d are disposed. Each of the operation objects 100c and 100d is an operation object capable of rotating, using a direction (first direction) perpendicular to the screen surface and a second direction (top and bottom direction of the screen) orthogonal to the first direction, as rotation axes. By performing an operation of inclining each of the operation objects 100c and 100d in the shapes of spherical bodies about the perpendicular direction (first direction) as the axis or rotating each of the operation objects 100c and 100d about the second direction (top and bottom direction of the screen) as the axis, the values displayed in the input information display fields 101c and 101d can be changed according to the angle of the inclination or the rotation. In the example in FIG. 7, display of various icons such as an antenna icon indicating a radio wave state or a battery icon indicating a battery charge that are normally displayed on the cellular phone terminal is omitted.

Next, the cellular phone terminal clears the no-operation timer unit 162, and then starts measurement of a no-operation period of time (in step a3).

When the non-operation timer unit 162 detects no operation for a certain period of time (Yes in step a4), the cellular phone terminal determines that there has been no input of the password, and performs an operation of turning off the backlight (by proceeding to step a9), thereby finishing the procedure. In this case, the cellular phone terminal remains in the operation locked state. The brightness of the backlight may be of course reduced a certain period of time before the operation of turning off the backlight is performed.

When a certain operation is performed from the user (No in step a4), the operation recognition unit 161 of the cellular phone terminal checks whether or not content of the operation is depression of a cancel button (refer to a “cancel” button in FIG. 7)(in step a5). When the “cancel” is depressed, the cellular phone terminal determines that user's intention not to perform input of the password has been indicated, thereby finishing the procedure (by proceeding to step a9). In this case as well, the cellular phone terminal remains in the operation locked state.

Next, the operation recognition unit 161 of the cellular phone terminal checks whether or not an input determination button (refer to a “determine” button in FIG. 7) has been depressed (in step a6). When an operation other than the operation of depressing the input determination button, such as an operation on the operation object 100c or 100d in FIG. 7 is performed (No in step a6), the operation recognition unit 161 of the cellular phone terminal moves the operation object 100c or 100d and also updates the values in the input information display fields 101c or 101d according to the content of the operation by the user (in step a10). Then, the cellular phone terminal clears the no-operation timer unit 162 again, thereby starting measurement of a no-operation period of time (in step a3).

On the other hand, when depression of the input determination button is detected (Yes in step a6), the authentication control unit 163 of the cellular phone terminal checks the values in the input information display fields 101c and 101d at that point against the registered password registered in the password storage unit 192 (in step a7).

When the values shown in the input information display fields 101c and 101d do not match the registered password as a result of the checking, the cellular phone terminal does not release the operation lock, and a transition to the screen for input of the password is made again (by proceeding to step a2). When mismatch of the password continues a predetermined number of times in this case, the cellular phone terminal may perform various alarming operations or may perform a notification operation through the radio unit 15, without returning to the screen for input of password.

On the other hand, when the values shown in the input information display fields 101c and 101d match the registered password as a result of the checking, the cellular phone terminal releases the operation lock (in step a8).

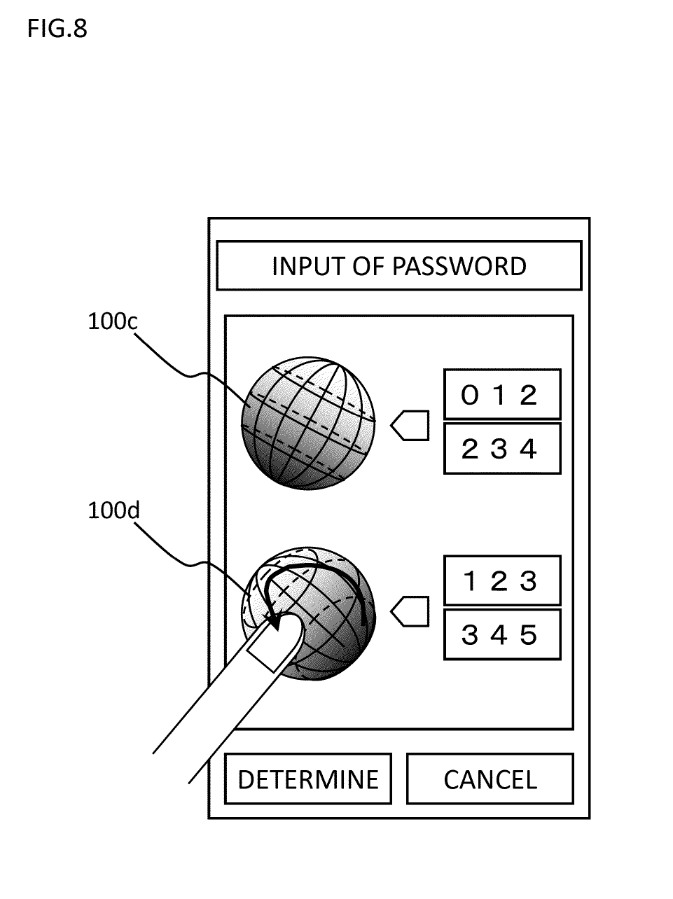

To take an example, when the input determination button is depressed in a state where the values in the input information display fields 101c and 101d have matched the registered password set in advance, as shown in FIG. 8, the operation lock is released. Thereafter, it becomes possible for the user to use the various functions of the cellular phone terminal.

As described above, according to this exemplary embodiment, a plurality of numbers of two or more digits can be simultaneously input by one operation on each operation object. In the case of the ten-key input method described as the background art which requires one operation for one character, for example, 12 times of operations on ten keys are needed for input of the password of 12 digits shown in FIG. 8. In this exemplary embodiment, by operating two operation objects each having two axes, by each of which input information changes corresponding to [rotation angle of] 0 to 360 degrees, passwords of a combination of the fourth power of 360 numbers can be input.

In this exemplary embodiment, input information is set to have three digits corresponding to each of 0 to 359 degrees in consideration of both of ease of operation and a password length. Needless to say, however, the number of digits for input or an imputable range can be changed. To take an example, when 0 to 999 degrees (less than three rotations of each operation object) are set as an input range, input of a password having the length of the fourth power of 1000 or 10¹² becomes possible. Similarly, it is also possible to define one rotation of the operation object as 999, and to change input information according to an amount of operation.

In the above-mentioned exemplary embodiment, the input information display fields 101c and 101d are provided. Then, the description was given, assuming that the values of these input information display fields 101c and 101d are to be changed according to an amount of operation by the user. Display of the input information display fields 101c and 101d can be omitted by providing over the surface of each of the operation objects 100c and 100d, coloring or a clear indication of a numerical value whereby an operation angle amount can be recognized, for example. Alternatively, by performing overlay display of a numerical value on each of the operation objects 100c and 100d themselves or by changing brightness, colorfulness, or hue of each of the input information display fields 101c and 101d [sic. “operation objects 100c and 100d”] according to a rotation amount in place of the input information display fields 101c and 101d [sic. “operation objects 100c and 100d”], the input information display fields 101c and 101d can be omitted.

In the case where strict numerical value selection would become difficult as a result of adopting the mode as mentioned above in which the above-mentioned input information is not displayed, an acceptance/rejection criterion for a password may be relaxed. Assume that the registered password of a combination of “012” and “234” and a combination of “123” and “345” in FIG. 5 is set, for example. Then, when the operation object 100c is operated in the ranges of “010 to 014”, “232 to 236” and the operation object 100d is operated in the ranges of “121 to 125” and “343 to 347”, the password resulting from these operations may be determined to match the registered password.

### Second Exemplary Embodiment

Next, with reference to drawings a description will be given in detail about a second exemplary embodiment where operation on an operation object is more facilitated than the first exemplary embodiment. Since the second exemplary embodiment can be implemented by a configuration similar to that of the first exemplary embodiment, and operation of the second exemplary embodiment is generally common with the first exemplary embodiment, a description will be given below, centering on a difference of the second exemplary embodiment from the first exemplary embodiment.

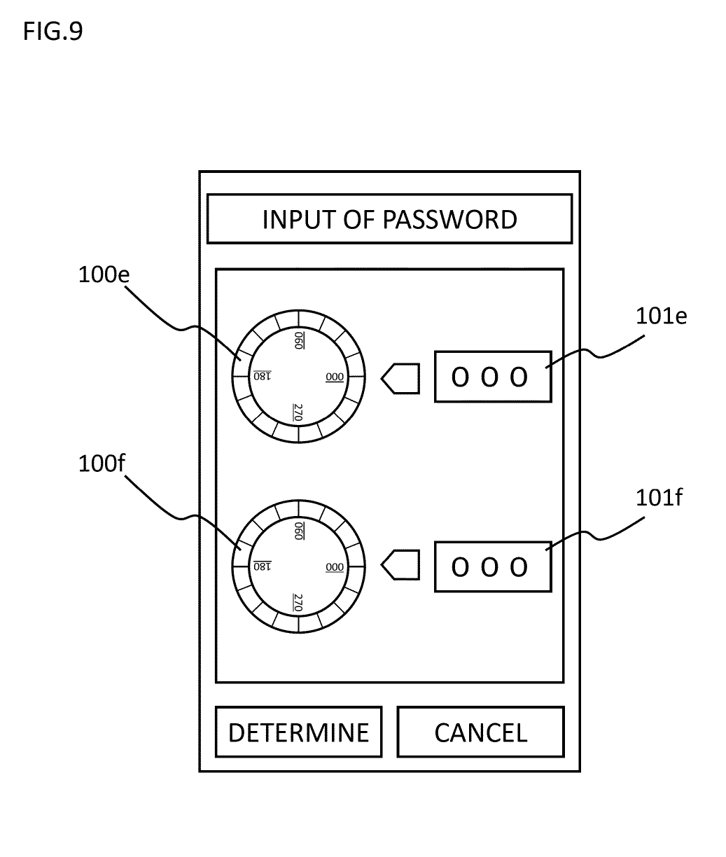

FIG. 9 shows an example of a password input screen displayed on a display unit 18 of a cellular phone terminal in this exemplary embodiment. In the second exemplary embodiment, two dial-like operation objects 100e and 100f are employed in a screen configuration, in contrast with the spherical operation objects in the first exemplary embodiment capable of being operated in the two directions. Input information display fields 101e and 101f whose values change according to movements of these operation objects 100e and 100f are provided on a side portion of the screen.

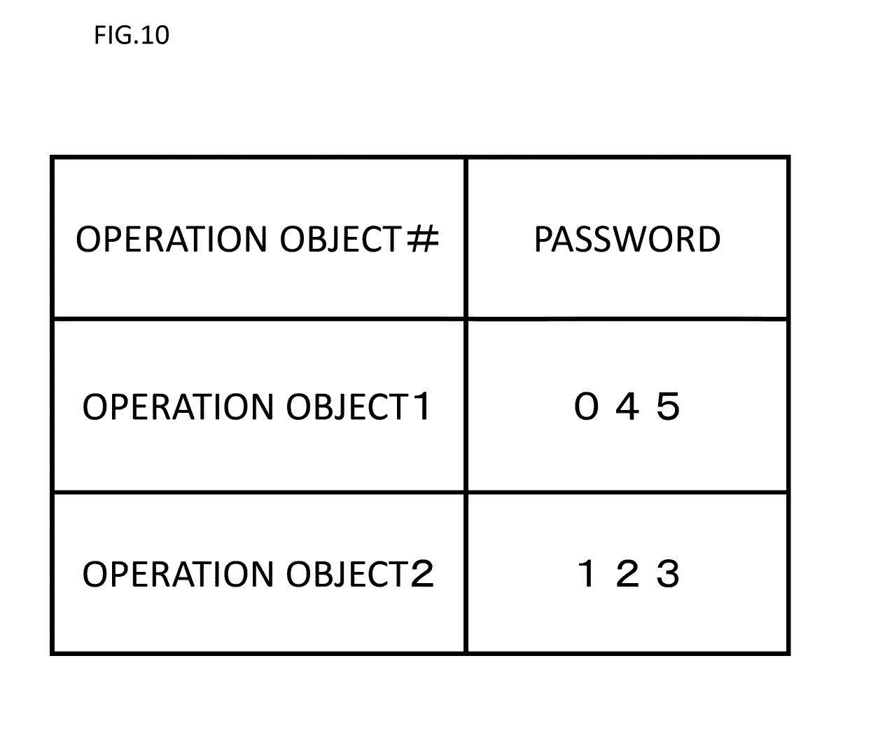

FIG. 10 shows an example of a registered password stored in a password storage unit 192 of the cellular phone terminal in this exemplary embodiment. In this exemplary embodiment, a six-digit password of “045123” is set. In the six-digit password, respective three-digit numbers are associated with respective operation object #1 (operation object 100e) and operation object #2 (operation object 100f).

In this exemplary embodiment, a user operates the operation object #1 such that input information becomes “045” and operates the operation object #2 such that input information becomes “123”, thereby completing input of a password identical to the registered password.

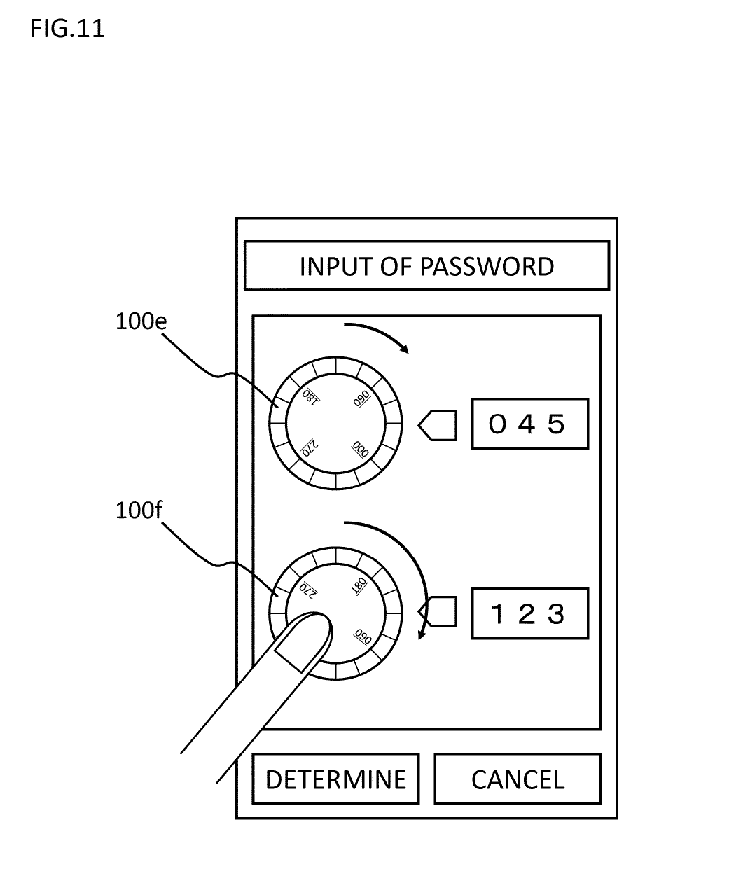

FIG. 11 shows an example of the password input screen in a state where the operation objects 100e and 100f have been operated such that the input information becomes identical to the registered password shown in FIG. 10. When an input determination button is depressed in this state, an operation lock is released. Thereafter, it becomes possible for the user to use various functions of the cellular phone terminal.

As described above, according to this exemplary embodiment, the dial-like operation objects 100e and 100f are employed, a limitation is added to a direction where each operation object can be operated, and the number of input information fields whose values change is reduced. Thus, operability can be more improved than in the above-mentioned first exemplary embodiment.

### Third Exemplary Embodiment

Next, with reference to drawings, a description will be given in detail about a third exemplary embodiment of the present invention where an operation object is changed, thereby allowing input information to be finely operated. This exemplary embodiment can also be implemented by a configuration similar to that in each of the first and second embodiments, and operation of this exemplary embodiment is generally common with each of the first and second embodiments. Thus, the following description will be given, centering on a difference of this exemplary embodiment from the first and second embodiments.

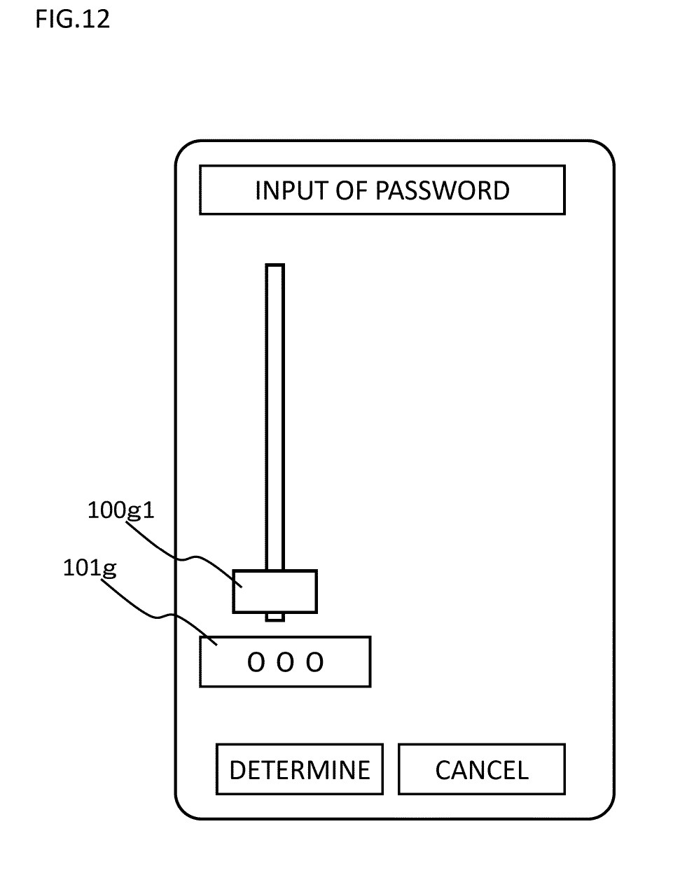

FIG. 12 shows an example of a password input screen displayed on a display unit 18 of a cellular phone terminal in this exemplary embodiment. Referring to FIG. 12, a screen configuration is provided in which one slider-like operation object 100g1 and an input information display field 101g are disposed as an initial state.

In the following description, the description will be given, assuming that a three-digit password of “639” is set in a password storage unit 192 of the cellular phone terminal.

When a user slides the slider-like operation object 100g1 shown in FIG. 12 to an upper portion of the screen, the value of a first one of input information from the left changes according to an amount of sliding.

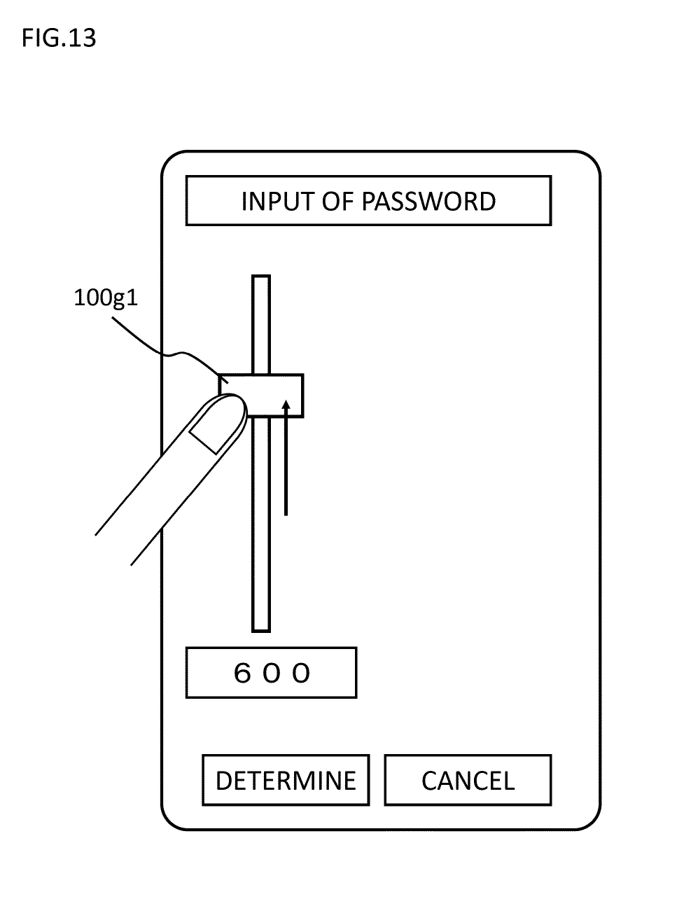

FIG. 13 is a diagram showing a state where the user has stopped moving a finger when the value of the first one of the input information from the left has assumed “6”. When the user slides the finger to the right in this state, the value of the first one of the input information is fixed to “6”, and a slider-like operation object 100g2 for changing the value of a second one of the input information from the left is displayed.

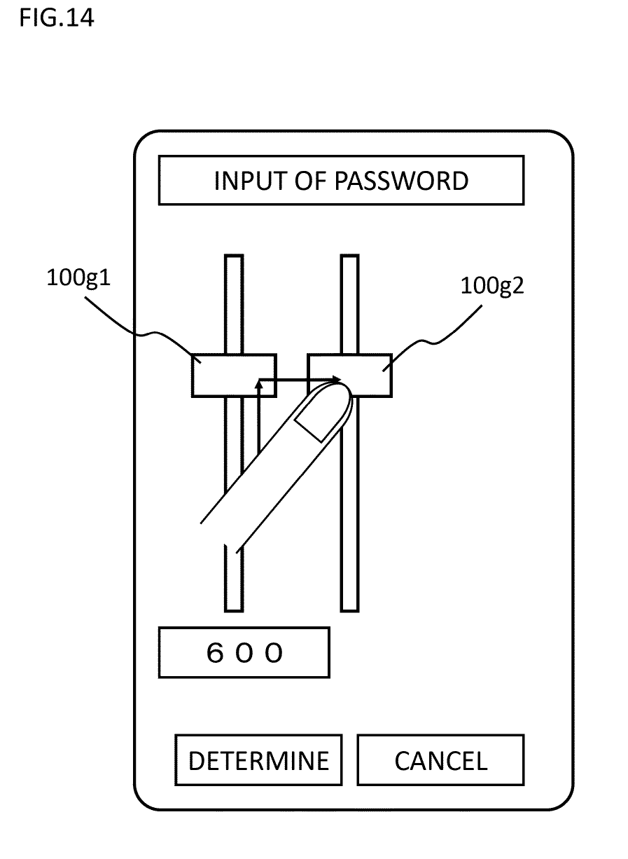

FIG. 14 is a diagram showing a state in which the first one of the input information from the left is fixed to “6”, and the slider-like operation object 100g2 for changing the value of the second one of the input information from the left is displayed. When the user slides the operation object 100g2 to a lower portion of the screen, the value of the second one of the input information from the left changes according to an amount of sliding.

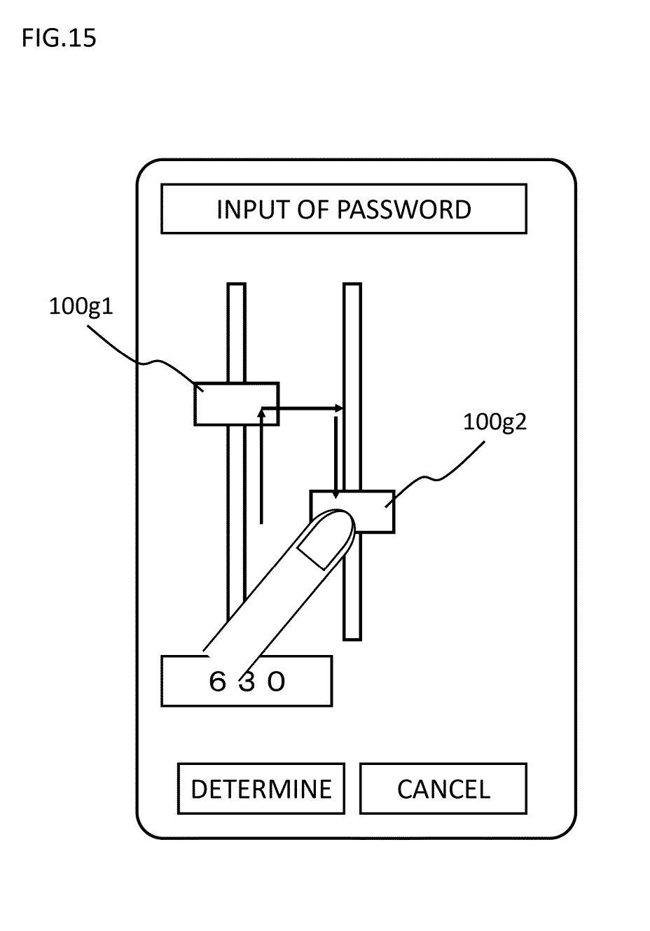

FIG. 15 is a diagram showing a state where the user has stopped moving the finger when the value of the second one of the input information from the left assumed “3”. When the user slides the finger to the right in this state, the value of the second one of the input information from the left is fixed to “3”, and a slider-like operation object 100g3 for changing the value of a third one of the input information from the left is further displayed.

Thereafter, similarly, assume that the user operates the slider-like operation object 100g3, the value of the third one of the input information from the left assumes “9”, and then the user stops moving the finger. Then, input of the three-digit password of “639” is completed.

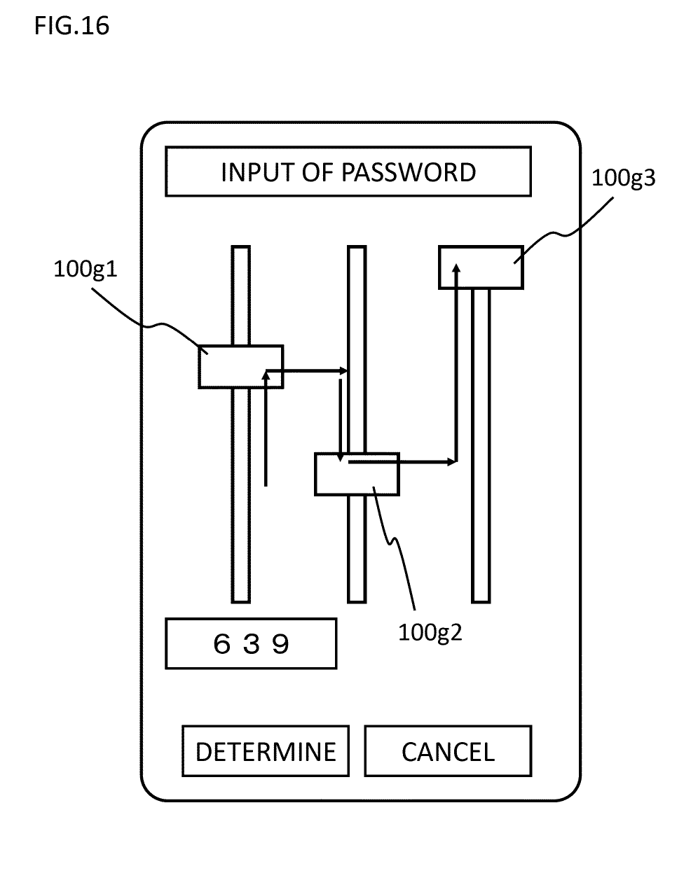

FIG. 16 shows an example of a password input screen where the operation objects 100g1 to 100g3 have been operated so that input information becomes the registered password of “639”. When an input determination button is depressed in this state, an operation lock is released. Thereafter, the user can use various functions of the cellular phone terminal.

As described above, according to this exemplary embodiment, it is so arranged that each digit of input information may be adjusted by a corresponding one of the slider-like operation objects 100g1 to 100g3. Thus, a fine value can be readily input, as compared with the above-mentioned first and second exemplary embodiments. As shown in FIG. 15 by arrow lines, movement of the finger of the user until input of the input operation is completed of course represents a single stroke. Thus, the advantage of the present invention of allowing a plurality of numbers or characters to be input in one operation is not lost.

In the above-mentioned exemplary embodiment, the description was given, assuming that the slider-like operation object is employed. The invention is, however, not limited to the slider-like operation object, and other GUI components may also be employed. Alternatively, a configuration may be adopted where, by moving a character or the like in a left/right direction or up/down direction from a starting point of the movement, adjustment of the value associated with each digit or each place of input information is completed.

Further, the number of digits and a numerical value range to be assigned to the individual slider-like operation object and the number of the slider-like operation objects can also be suitably changed, as in the above-mentioned first and second exemplary embodiments.

### Fourth Exemplary Embodiment

Next, with reference to drawings, a description will be given in detail about a fourth exemplary embodiment in which an operation object is altered. This exemplary embodiment can also be implemented by a configuration similar to that in each of the first to third embodiments, and operation of this exemplary embodiment is generally common with each of the first to third embodiments. Thus, the following description will be given, centering on a difference of this exemplary embodiment from the first to third embodiments.

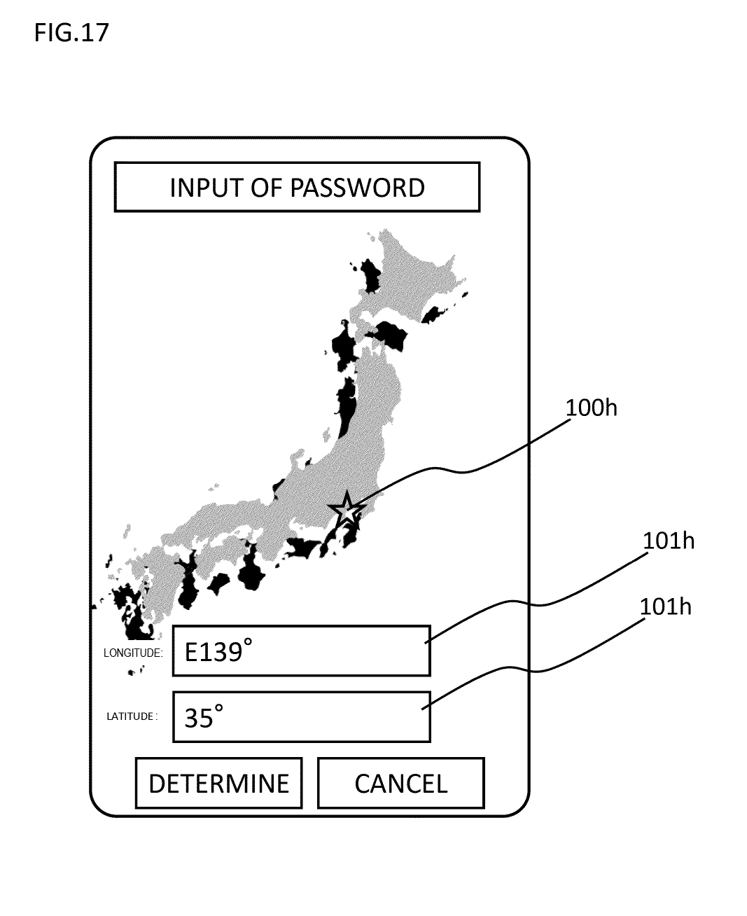

FIG. 17 shows an example of a password input screen displayed on a display unit 18 of a cellular phone terminal in this exemplary embodiment. Referring to FIG. 17, a screen configuration is provided in which a star-shaped operation object 100h displayed like a marker on a map and input information display fields 101h displaying the latitude and the longitude of the operation object 100h are disposed as an initial state.

In the following description, the description will be given, assuming that latitude and longitude information of “N35° 34′ 31″” and “E139° 39′ 53″” to be used as a password is set in a password storage unit 192 of the cellular phone terminal.

In the map in FIG. 17 displaying the entire region of Japan, it is difficult to adjust the values of the input information display fields to the fine latitude and longitude as described above, by an operation on the star-shaped operation object 100h. Then, a user performs a pinch-out operation (of widening a space between two fingers of the user) at a position on the map shown in FIG. 17 corresponding to the latitude and the longitude of the operation object in order to specify the fine latitude and longitude. Then, a map showing enlargement of a corresponding region is displayed.

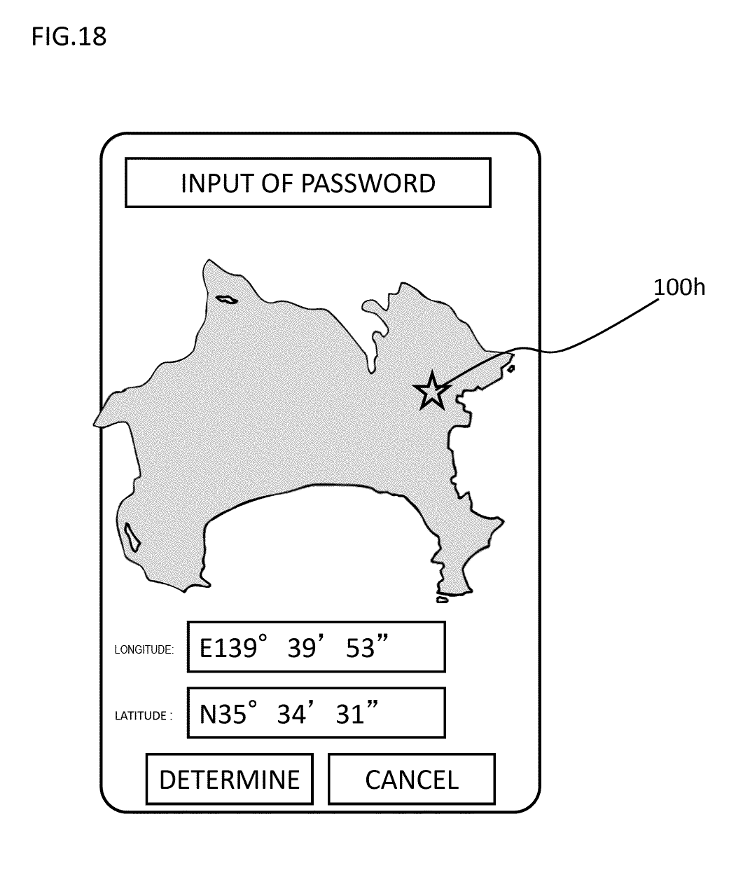

FIG. 18 is a diagram showing a state where the values of the input information display fields have assumed “N35° 34′ 31″” and “E139° 39′ 53″” described above after the user has performed the pinch-out operation in the vicinity of the star-shaped operation object 100h in FIG. 17 and then has performed a drag operation on the star-shaped operation object 100h. When an input determination button is depressed in this state, an operation lock is released. Thereafter, the user can use various functions of the cellular phone terminal.

As described above, the present invention can be implemented also by a mode where the operation object on the map is operated. In this exemplary embodiment, as latitude and longitude to be used for a password, the latitude and longitude using a landmark, a user's home, or a special location that is known only to a relative of the user on the map can be set as a target. Thus, it becomes easy for the user to memorize the password.

In the above-mentioned exemplary embodiment, the description was given about the case where the target latitude and the target longitude could be input by one pinch-out operation. A plurality of pinch out operations, however, may be of course performed.

In the above-mentioned exemplary embodiment, the description was given, pointing out the example where the map of a plane was used. It may also be so arranged that by drawing a map on the surface of the spherical operation object in the above-mentioned first exemplary embodiment, input information is set, using latitude and longitude.

In the above-mentioned exemplary embodiment, the description was given, assuming that latitude and longitude information is to be used as input information. Other positional information, however, can also be used as the input information. To take an example, a configuration can also be employed in which a symbol or a number assigned to each grid on a map, coordinate information based on the origin that has been separately defined, or the like is altered to be selected as the input information.

### Fifth Exemplary Embodiment

Next, with reference to drawings, a description will be given in detail about a fifth exemplary embodiment in which input information input by operating an operation object is used as a calling telephone number. This exemplary embodiment can also be implemented by a configuration similar to that in each of the first to fourth embodiments, and operation of this exemplary embodiment is generally common with each of the first to fourth embodiments. Thus, the following description will be given, centering on a difference of this exemplary embodiment from the first to fourth embodiments.

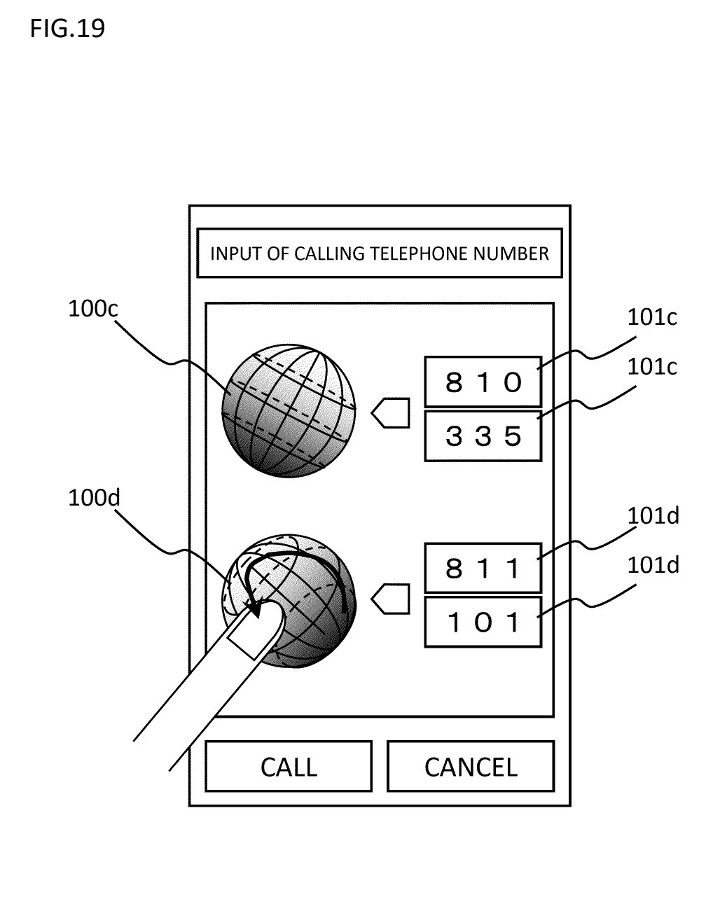

FIG. 19 shows an example of a screen for input of a calling telephone number displayed on a display unit 18 in this exemplary embodiment. In the example in FIG. 19, two spherical operation objects 100c and 100d and four input information display fields 101c and 101d whose values change according to movement of these operation objects 100c and 100d are disposed, as in the first exemplary embodiment described before.

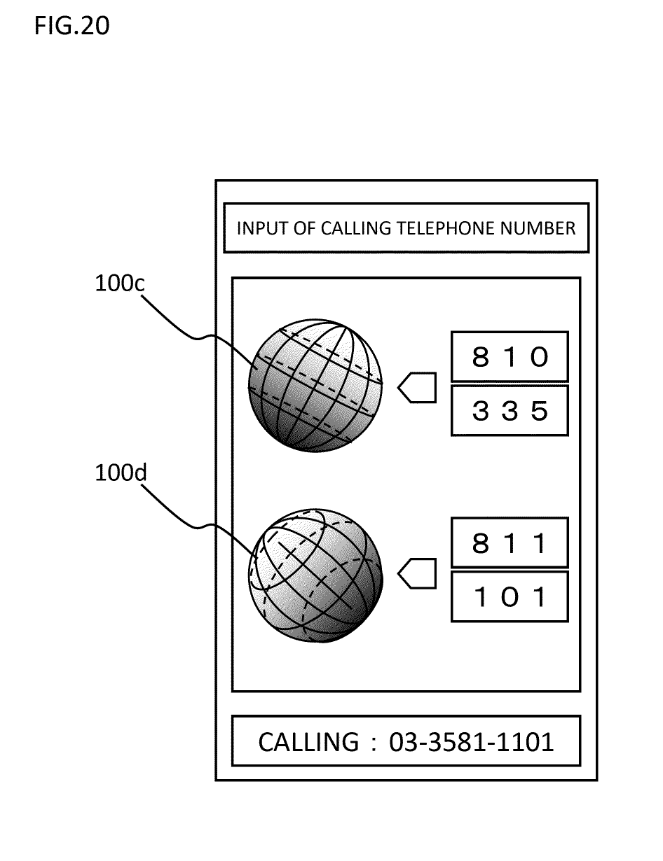

Assume, for example, that a calling button is depressed in a state where a telephone number desired to be called is displayed in the input information display fields 101c and 101d, as shown in FIG. 19. Then, a control unit 16 of the cellular phone terminal starts a telephone calling process, based on the input information received from an operation recognition unit 161, as shown in FIG. 20.

As described above, the present invention is not limited to input of a password in a user authentication process, and can also be used for input of various numerical values, various codes, and various phrases such as a telephone number. By arranging such that the number of digits necessary for a telephone number may be represented without using the two spherical operation objects 100c and 100d as shown in FIG. 19, the operation objects used in the above-mentioned second to fourth exemplary embodiments can also be of course used.

### Sixth Exemplary Embodiment

Next, with reference to drawings, a description will be given in detail about a sixth exemplary embodiment of the present invention in which, using input information input by operating an operation object, a function of calling up telephone directory data is implemented. This exemplary embodiment can also be implemented by a configuration similar to that in each of the first to fifth embodiments, and operation of this exemplary embodiment is generally common with each of the first to fifth embodiments. Thus, the following description will be given, centering on a difference of this exemplary embodiment from the first to fifth embodiments.

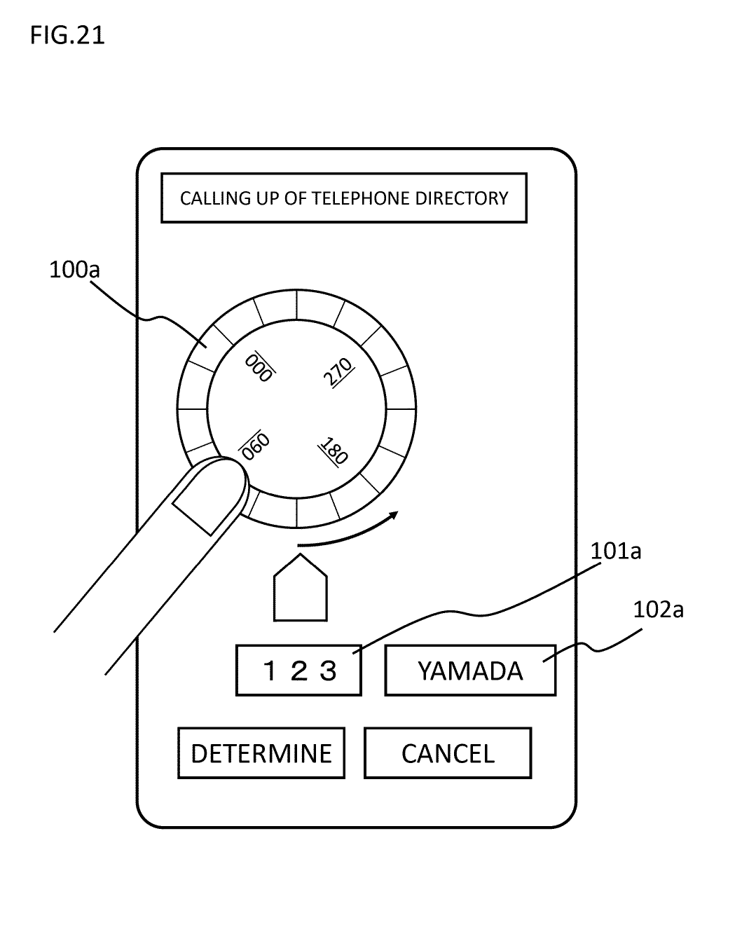

FIG. 21 shows an example of a screen for calling up a telephone directory displayed on a display unit 18 of a cellular phone terminal in this exemplary embodiment. In the example in FIG. 21, a dial-like operation object 100a similar to the operation object in the second exemplary embodiment described before, an input information display field 101a whose value changes according to movement of the dial-like operation object 100a, and a data display field 102a configured to display a portion of telephone directory data displayed in the input information display field 101a are disposed.

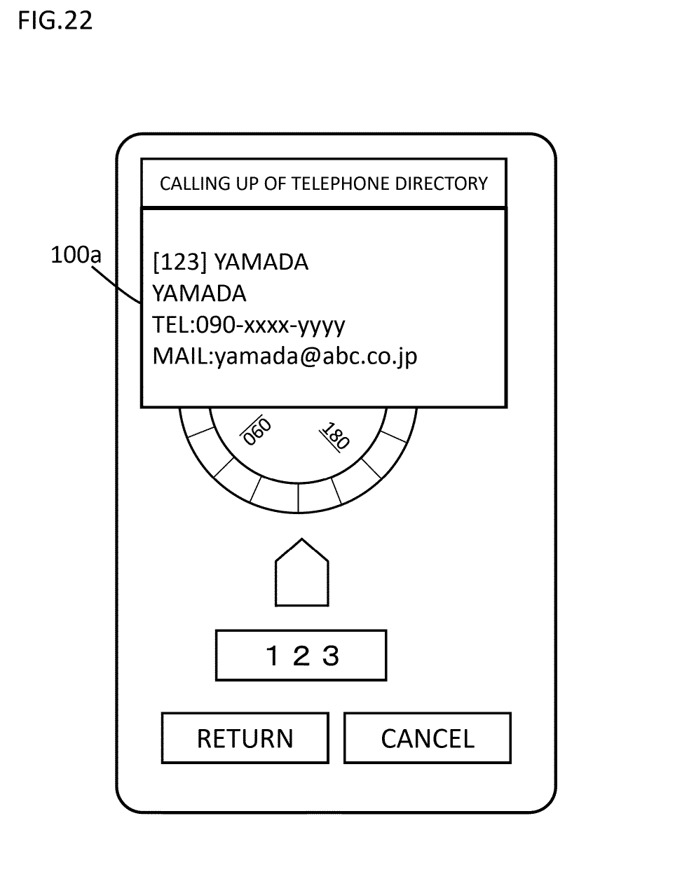

Assume, for example, that content of the data display field 102a is referred to while operating the operation object 100a, and then a determination button is depressed when desired data is displayed. Then, a control unit 16 of the cellular phone terminal reads, from the telephone directory, data corresponding to input information received from an operation recognition unit 161, and displays the read data, as shown in FIG. 22.

As described above, the present invention is not limited to input of a password for a user authentication process, and can be used also when telephone directory data is called up, or the like. Further, the operation object used in each of the above-mentioned first, third, and fourth exemplary embodiments can also be used in this exemplary embodiment, in addition to the dial-like operation object used in the above-mentioned second embodiment.

### Seventh Exemplary Embodiment

Next, with reference to drawings, a description will be given in detail about a seventh exemplary embodiment in which a display timing of an operation on an operation object is changed. This exemplary embodiment can also be implemented by a configuration similar to that in each of the first to sixth embodiments, and operation of this exemplary embodiment is generally common with each of the first to sixth embodiments. Thus, the following description will be given, centering on a difference of this exemplary embodiment from the first to sixth embodiments.

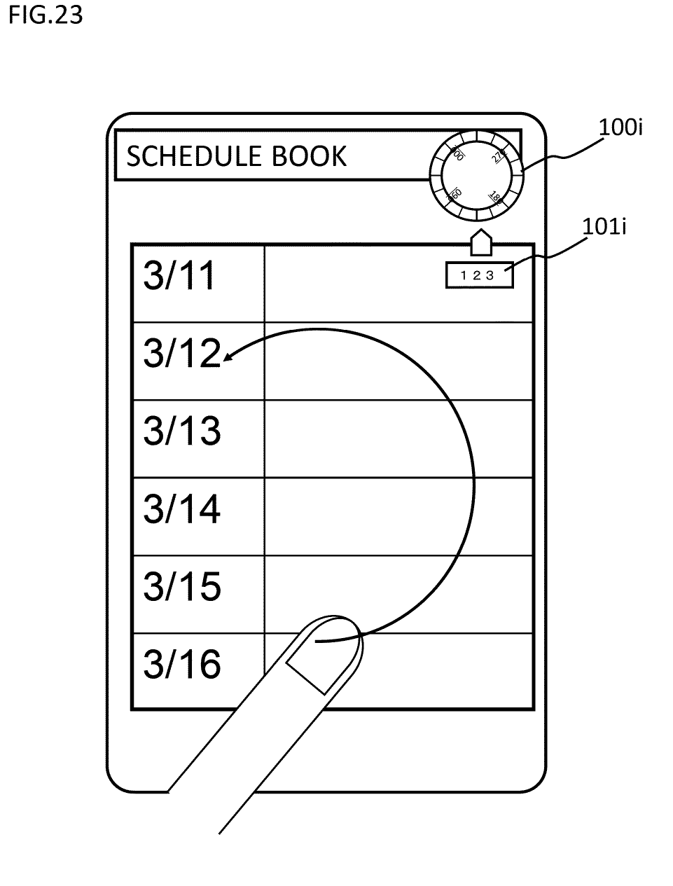

FIG. 23 shows an example of a screen of a schedule book displayed on a display unit 18 of a cellular phone terminal in this exemplary embodiment. The example in FIG. 23 shows a state where a dial-like object 100i similar to the operation object in the second exemplary embodiment and an input information display field 101i whose value changes according to movement of the dial-like object 100i are displayed in an upper right portion of the screen, during use of the schedule book by a user.

When the user moves a finger to a direction in which the dial-like object 100i is desired to be rotated, as shown by an arrow line in FIG. 23, the dial-like object 100i rotates in the direction.

Then, when a certain period of time elapses with the registered password of the user displayed in the input information display field 101i, an authentication control unit 163 of the cellular phone terminal regards that the determination operation of input content has been made, and then executes user authentication, using input information received from an operation recognition unit 161.

When the user authentication succeeds as a result of the user authentication, the user can continue using the function of the schedule book. On the other hand, when the user authentication fails, use of the function of the schedule book is prohibited or limited.

As described above, the present invention can also be applied to a user authentication process during use of a specific function.

No limitation is imposed on the size of the operation object to be displayed on the display unit 18 as shown in FIG. 23, which is not limited to this exemplary embodiment. To take an example, a mode can also be adopted in which, by preferentially reading content of an operation on a touch panel 171, an operation object and the value of an input information display field are changed.

### Eighth Exemplary Embodiment

Next, a description will be given about an eighth exemplary embodiment of the present invention in detail, with reference to drawings. This exemplary embodiment can also be implemented by a configuration similar to that in each of the first to seventh embodiments, and operation of this exemplary embodiment is generally common with each of the first to seventh embodiments. Thus, the following description will be given, centering on a difference of this exemplary embodiment from the first to seventh embodiments.

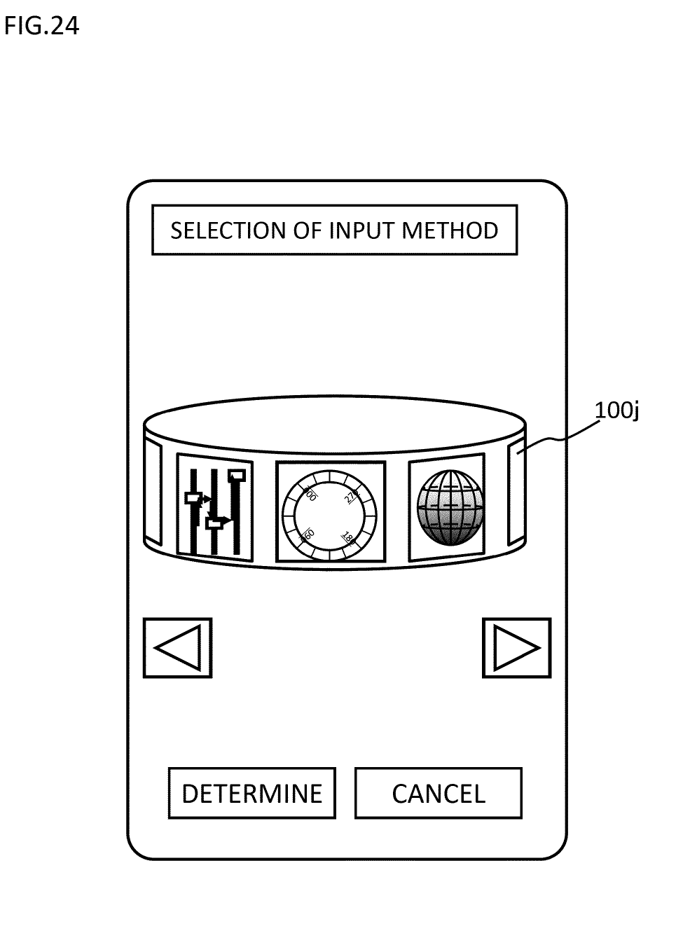

FIG. 24 shows an example of a screen for selection of an input method displayed on a display unit 18 of a cellular phone terminal in this exemplary embodiment. Referring to FIG. 24, an input method selection object 100j representing each input method using the operation object in each of the above-mentioned first to third exemplary embodiments is displayed in the center of the screen.

Assume, for example, that the screen for selection of an input method in FIG. 24 is displayed, as a screen for setting a user authentication process. Then, when a user selects the dial-like operation object located in the center of FIG. 24, user authentication using the dial-like operation object is performed, as in the above-mentioned second exemplary embodiment. Similarly, when the user selects the spherical operation object located on the right side of FIG. 24, user authentication using the spherical operation object is performed, as in the above-mentioned first exemplary embodiment.

As described above, according to this exemplary embodiment, a suitable input method can be selected according to user's preference, or the size of the display screen or the type of a pointing device provided as an operation unit in a terminal device to which the present invention is applied.

The above-mentioned description was directed to the preferred exemplary embodiments of the present invention. The present invention is not, however, limited to the above-mentioned exemplary embodiments, and further variation, substitution, and adjustment can be added within the scope not departing from the basic technical concept of the present invention. To take an example, the description of the above-mentioned exemplary embodiments was given, assuming that a value to be displayed in each input information display field is a numerical value or latitude or longitude information, which changes in an ascending or descending order according to movement of each operation object. It may also be so arranged that a character or a symbol is displayed in each input information display field or on each operation object itself, and the character or the symbol is changed in kana syllabary order or alphabetical order.

The description of each of the above-mentioned exemplary embodiments was given, listing up the example where the present invention is applied to the cellular phone terminal. The present invention can also be applied to a terminal device such as a personal computer or a terminal for business use other than the cellular phone terminal.

The present invention can be suitably adopted for an input screen of a password or a transfer destination account number in an ATM (Automated Teller Machine) of a bank. The present invention can be of course adopted for a password input screen for a security system installed in a house or an office.

Since the present invention produces no keystroke as described above, keystroke-stealing by spyware or the like can be made to be difficult.

Each disclosure of the above-mentioned Patent Literatures is incorporated herein by reference. Modification and adjustment of each exemplary embodiment and each example are possible within the scope of the overall disclosure (including the claims) of the present invention and based on the basic technical concept of the present invention. Various combinations and selections of various disclosed elements (including each element of each claim, each element of each example, each element of each drawing, and the like) are possible within the scope of the claims of the present invention. That is, the present invention naturally includes various variations and modifications that could be made by those skilled in the art according to the overall disclosure including the claims and the technical concept. With respect to a numerical value range described herein in particular, an arbitrary numerical value and a small range included in the numerical value range should be construed to be specifically described even unless otherwise explicitly described.

Finally, preferred modes of the present invention are summarized.

[First Mode]

(See the terminal device according to the first aspect described above).

[Second Mode]

The terminal device according to the first mode, wherein the operation recognition unit displays the input information on the display unit.

[Third Mode]

The terminal device according to the first or second mode, wherein the operation unit is a pointing device.

[Fourth Mode]

The terminal device according to any one of the first to third modes, wherein

the operation recognition unit changes each of a plurality of input information according to an amount and a direction of the operation on the operation object; and

the operation object is operated such that each of the plurality of input information items assumes a desired value, thereby allowing simultaneous input of the plurality of input information items.

[Fifth Mode]

The terminal device according to any one of the first to third modes, wherein

the operation object is an operation object capable of rotating about rotation axes extending in a first direction and a second direction orthogonal to the first direction; and

the input information changes according to traversed angle of the operation object about each of the first direction (axis) and the second direction (axis) moved from a reference position by movement of the operation object.

[Sixth Mode]

The terminal device according to any one of the first to third modes, wherein

the operation object comprises a plurality of operation objects associated with respective digits or respective places of the input information having a length of two or more digits or two or more characters.

[Seventh Mode]

The terminal device according to any one of the first to third modes, wherein

the operation object is an operation object indicating a position on a map, and the input information changes according to positional information indicated by the operation object.

[Eighth Mode]

The terminal device according to the first or seventh modes, wherein the control unit performs a user authentication process using the input information.

[Ninth Mode]

The terminal device according to the first or eighth modes, wherein the control unit performs an address book data selection process using the input information.

[Tenth Mode]

The terminal device according to the first or ninth mode, wherein the control unit performs a telephone calling process using the input information as a telephone number.

[Eleventh Mode]

(See the information input method according to the second aspect described above).

[Twelfth Mode]

The information input method according to the eleventh mode, wherein in the step of changing the input information having the length of two or more digits or two or more characters according to the amount of the operation on the operation object and based on the predetermined rule, the input information is displayed.

[Thirteenth Mode]

The information input method according to the eleventh or twelfth mode, comprising:

changing each of a plurality of input information items according amount of the operation on the operation object and a direction of the operation on the operation object; and

operating the operation object such that each of the plurality of input information items assumes a desired value, thereby allowing simultaneous input of the plurality of input information.

[Fourteenth Mode]

(See the program according to the third aspect described above).

[Fifteenth Mode]

The program according to the fourteenth mode, wherein the program causes the computer to execute a process of: displaying the input information together the process of changing the input information having the length of two or more digits or two or more characters according to the amount of the operation on the operation object and based on the predetermined rule.

### REFERENCE SIGNS LIST

1, 17 operation unit
2, 18 display unit
3, 161 operation recognition unit
4, 16 control unit
11 power supply unit
12 transmitter unit
13 receiver unit
14 loudspeaker
15 radio unit
19 storage unit
100a˜100h, 100g1˜100g3 operation object
100i object
100j input method selection object
101a˜101i input information display field
102a data display field
162 no-operation timer unit
163 authentication control unit
171 touch panel
191 setting storage unit
192 password storage unit

1. A terminal device, comprising:
an operation unit configured to receive an operation from a user;
a display unit configured to display an operation object capable of being operated by the user;
an operation recognition unit configured to change input information having a length of two or more digits or two or more characters according to an amount of operation on the operation object and based on a predetermined rule; and
a control unit configured to perform a predetermined process using input information selected by an operation on the operation object.

2. The terminal device according to claim 1, wherein
the operation recognition unit displays the input information on the display unit.

3. The terminal device according to claim 1, wherein
the operation unit is a pointing device.

4. The terminal device according to claim 1, wherein
the operation recognition unit changes each of a plurality of input information according to an amount and a direction of the operation on the operation object; and
the operation object is operated such that each of the plurality of input information items assumes a desired value, thereby allowing simultaneous input of the plurality of input information items.

5. The terminal device according to claim 1, wherein
the operation object is an operation object capable of rotating as rotation axes extending in a first direction and a second direction orthogonal to the first direction; and
the input information changes according to traversed angle of the operation object about each of the first direction and the second direction moved from a reference position by movement of the operation object.

6. The terminal device according to claims 1, wherein
the operation object comprises a plurality of operation objects associated with respective digits or respective places of the input information having a length of two or more digits or two or more characters.

7. The terminal device according to claim 1, wherein
the operation object is an operation object indicating a position on a map, and the input information changes according to positional information indicated by the operation object.

8. The terminal device according to claim 1, wherein
the control unit performs a user authentication process using the input information.

9. The terminal device according to claim 1, wherein
the control unit performs an address book data selection process using the input information.

10. The terminal device according to claim 1, wherein
the control unit performs a telephone calling process using the input information as a telephone number.

11. An information input method, comprising the steps of:
displaying on a display device an operation object capable of being operated by a user;
changing input information having a length of two or more digits or two or more characters according to an amount of operation on the operation object and based on a predetermined rule; and
receiving selection of input information by a predetermined operation.

12. The information input method according to claim 11, wherein
in the step of changing the input information having the length of two or more digits or two or more characters according to the amount of operation on the operation object and based on the predetermined rule,
the input information is displayed.

13. The information input method according to claim 11, comprising:
changing each of a plurality of input information items according an amount of operation on the operation object and a direction of the operation on the operation object; and
operating the operation object such that each of the plurality of input information items assumes a desired value, thereby allowing simultaneous input of the plurality of input information.

14. A computer-readable storage medium storing a program for causing a computer including an operation unit configured to receive an operation from a user and a display unit, the program causing the computer to execute a processes of:
displaying an operation object capable of being operated by the user;
changing input information having a length of two or more digits or two or more characters according to an amount of operation on the operation object and based on a predetermined rule; and
receiving selection of input information by a predetermined operation.

15. The computer-readable storage medium storing a program according to claim 14, wherein the program causes the computer to execute a process of:
displaying the input information together with the process of changing the input information having the length of two or more digits or two or more characters according to the amount of the operation on the operation object and based on the predetermined rule.
